(19) United States
(12) Patent Application Publication
(10) Pub. No.: US 2007/0038784 A1
(43) Pub. Date: Feb. 15, 2007

(54) Flow control method in wireless USB communication, and wireless USB device and wireless USB host using the same

(75) Inventors: Hyun-ah Sung, Seoul (KR); Dae-gyu Bae, Suwon-si (KR); Jin-woo Hong, Suwon-si (KR); Se-hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,305

(22) Filed: Jul. 17, 2006

(30) Foreign Application Priority Data
Aug. 9, 2005 (KR) 10-2005-0072768

(51) Int. Cl. G06F 3/00

(52) U.S. Cl. 710/56

(57) ABSTRACT

A flow control method in wireless Universal Serial Bus (USB) communication, and a wireless USB device and a wireless USB host using the same are provided. The flow control method includes receiving a wireless USB communication management packet including channel time allocation information and information on a data transfer direction for one or more wireless USB devices that can communicate with a wireless USB host. The received wireless USB communication management packet is analyzed, and when the wireless USB device is short of a storage space for storing data received from the wireless USB host or when data to be transferred to the wireless USB host is not ready, a response packet including information on a time when the storage space or the data to be transferred to the wireless USB host will be prepared is generated in response to the wireless USB communication management packet. Then, the generated response packet is transmitted to the wireless USB host.

### CROSS REFERENCE TO RELATED APPLICATION

This application claims priority from Korean Patent Application No. 10-2005-0072768 filed on Aug. 9, 2005 in the Korean Intellectual Property Office, the disclosure of which is incorporated herein by reference in its entirety.

### BACKGROUND OF THE INVENTION

1. Field of the Invention

Methods consistent with the present invention relates to flow control in wireless Universal Serial Bus (USB) communication, and more particularly to efficiently controlling a flow between a wireless USB host and a wireless USB device by informing the wireless USB host of information on a time when the wireless USB device will be ready for data transfer.

2. Description of the Prior Art

USB is widely used for connecting personal computers (PCs) and peripheral devices, and its use is expanding from simple devices such as mice and keyboards to multimedia devices such as a camcorders and digital cameras. With the advent of wireless network environments, wireless USB employing UWB (Ultra Wide Band) technology is being increasingly utilized.

As in wired USB, wireless USB does not provide communication between wireless USB devices, but provides point-to-point communication between a wireless USB host and a wireless USB device. In wired USB, all communications between a wired USB host and a wired USB device are generated by a poll of the wired USB host with respect to the wired USB device. That is, when the wired USB host intends to transfer data to the wired USB device, the wired USB host can transfer data to the wired USB device by transmitting an OUT token to the wired USB device. Also, when the wired USB device intends to transfer data to the wired USB host, the wired USB host transmits an IN token to the wired USB device, thereby enabling the wired USB device to transmit the data to the wired USB host.

In wireless USB, the wireless USB host does not personally transmit the OUT/IN token to the wireless USB device, but allocates a channel time to be used by each wireless USB device and sets a communication direction (reception directions or transmission directions) of the wireless USB device by using a Wireless USB Channel Time Allocation Information Element (WCTA IE) within a Micro-scheduled Management Command (MMC) packet. In this way, the wireless USB host operates in a Time Division Multiple Access (TDMA) scheme. However, communication in wireless USB is similar to communication in wired USB in that all communications are basically initialized from the wireless USB host. Hereinafter, a USB host will be referred to as “a host” and a USB device will be referred to as “a device” for explanatory convenience.

FIGS. 1A and 1B illustrate a comparison of the wireless USB transaction protocol and the wired USB transaction protocol.

As stated above, similar to wired USB, wireless USB is a protocol based on the poll and the TDMA scheme. A host controller initiates all data transfers. Logically, each data transfer includes three packets, i.e., a token, data and a handshake, as in wired USB. However, in order to enhance the use efficiency of a physical layer by removing exhaustive transition between transmission and reception, the host combines a plurality of token information into one management packet. Using the management packet, the host indicates a specific time when a pertinent device must wait for an OUT data packet or a time when an IN data packet or a handshake must be transmitted.

In FIG. 1A, the wired USB transaction protocol 100 is shown as a protocol consisting of OUT transfer 110, i.e., data transfer from a host to a device, and IN transfer 120, i.e., data transfer from the device to the host. As mentioned above, the OUT transfer or the IN transfer of the wired USB includes a token packet 111 or 121 including information on a channel time allocated to each transfer and information on a communication direction of the device, an actual data packet 112 or 122 and a handshake packet 113 or 123 including information on a data transfer result. Thus, the communication transitions between the data packet 112 and the handshake packet 113, between the handshake packet 113 and the token packet 121, between the token packet 121 and the data packet 122, and others, which causes delay.

In FIG. 1B, the wireless USB transaction protocol 200 has an Information Element (IE) within a wireless USB communication management packet, i.e., an MMC packet 210, which includes information 211 to 213 corresponding to the tokens in the wired USB communication, and broadcasts the MMC packet 210 to all devices within range of the host to inform them of information on a channel time when each device can communicate with the host, and information on a communication direction of each device. In the case of FIG. 1B, the host transfers data to the device at a channel time corresponding to an OUT token 211 (data OUT operation 220), and the device transfers data to the host at a channel time corresponding to an IN token 212 (data IN operation 230). At a channel time corresponding to handshake OUT 213, the device transmits a result of the data transfer that has been conducted in the data OUT operation 220. Similar to wired USB communication, the MMC 210 including information corresponding to the token packets, the data OUT/IN operation 220, 230 and the handshake operation 240 forms one transaction group 201.

In this way, wireless USB may enhance the data transfer efficiency as compared with the wired USB communication by scheduling wireless USB communications with one or more devices through the MMC. However, since all data communications are still initiated from the host, there is a problem in that the devices must wait until the host allocates channel times thereto even though they are ready to participate in data transfer.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a flow control method in wireless USB communication capable of efficient data transfer by using a handshake packet for informing a wireless USB host of a time when a wireless USB device will be ready for data transfer or data reception, and a wireless USB host and a wireless USB device using such a flow control method.

In accordance with one aspect of the present invention, there is provided a flow control method in wireless USB communication, the method including receiving a wireless USB communication management packet including channel time allocation information and information on a data transfer direction for one or more wireless USB devices that is within range of a wireless USB host; analyzing the wireless USB communication management packet; when the wireless USB device is short of a storage space for storing data received from the wireless USB host or when data to be transferred to the wireless USB host is not prepared, generating a response packet including information on a time when the storage space or the data to be transferred to the wireless USB host will be ready, in response to the wireless USB communication management packet; and transmitting the response packet to the wireless USB host.

In accordance with another aspect of the present invention, there is provided a flow control method in wireless USB communication, the method including broadcasting a first wireless USB communication management packet including channel time allocation information and information on a data transfer direction for one or more wireless USB devices that is within range of a wireless USB host; receiving a response packet, which includes either information on a time when a storage space for storing data transferred from the wireless USB host to the wireless USB device will be prepared or information on a time when data to be transferred from the wireless USB device to the wireless USB host will be ready, from at least one of the one or more wireless USB devices; extracting the information on a time when the storage space will be ready or the information on a time when the data to be transferred to the wireless USB host will be ready, from the response packet; generating a second wireless USB communication management packet including channel time allocation information for the wireless USB device that has transmitted the response packet, according to the extracted information; and broadcasting the second wireless USB communication management packet.

In accordance with another aspect of the present invention, there is provided a wireless USB device including a transmission/reception unit that receives a wireless USB communication management packet including channel time allocation information and information on a data transfer direction for one or more wireless USB devices within range of a wireless USB host; a management packet processing unit that analyzes the wireless USB communication management packet; a data transfer status management unit that checks whether there is a sufficient storage space for storing data transferred from the wireless USB host when the information on a data transfer direction represents data transfer from the wireless USB host to the wireless USB device, or whether data to be transferred to the wireless USB host is ready when the information on a data transfer direction represents data transfer from the wireless USB device to the wireless USB host; a control unit that estimates a time when the storage space or the data to be transferred to the wireless USB host will be ready in a case where there is no storage space for storing the data transferred from the wireless USB host or the data to be transferred to the wireless USB host is not ready; and a response packet generation unit that produces a response packet including information on the estimated time, in response to the wireless USB communication management packet.

In accordance with another aspect of the present invention, there is provided a wireless USB host including a transmission/reception unit that receives a response packet that includes either information on a time when a storage space for storing data transferred from the wireless USB host to a wireless USB device will be ready or information on a time when data to be transferred from the wireless USB device to the wireless USB host will be ready, from the wireless USB device; a response packet processing unit that analyzes the response packet to extract the information on a time when the storage space will be ready or the information on a time when the data will be ready; a timing management unit that allocates a channel time for the wireless USB device having transferred the response packet while reflecting the extracted information to the allocation; a management packet generation unit that generates a wireless USB communication management packet including information on channel time allocation information and information on a data transfer direction for the wireless USB device; and a control unit that controls operations of the transmission/reception unit, the response packet processing unit, the timing management unit and the management packet generation unit.

Other detailed aspects of the present invention are included in the following detailed description and the accompanying drawings.

### BRIEF DESCRIPTION OF THE DRAWINGS

The above and other aspects of the present invention will be more apparent from the following detailed description of exemplary embodiments taken in conjunction with the accompanying drawings, in which:

FIGS. 1A and 1B are views comparing a wireless USB transaction protocol to a wired USB transaction protocol;

FIG. 2 is a view illustrating an overall system architecture consisting of a wireless USB host and wireless USB devices;

FIG. 3 is a view illustrating a principle of an MMC for scheduling data communication between a wireless USB host and a wireless USB device;

FIG. 4 is a view illustrating a protocol according to which a wireless USB device transits a DNTS (Device Notification Time Slot) message to a wireless USB host;

FIG. 5 is a view illustrating a format of a handshake packet which a wireless USB device transmits to a wireless USB host for flow control in accordance with an exemplary embodiment of the present invention;

FIG. 6 is a view illustrating a handshake packet which a wireless USB device transmits to a wireless USB host for flow control in accordance with another exemplary embodiment of the present invention;

FIG. 7 is a flowchart illustrating operational procedures of a wireless USB device in accordance with an exemplary embodiment of the present invention;

FIG. 8 is a flowchart illustrating operational procedures of a wireless USB host in accordance with an exemplary embodiment of the present invention;

FIG. 9 is a block diagram illustrating a configuration of a wireless USB device in accordance with an exemplary embodiment of the present invention; and

FIG. 10 is a block diagram illustrating a configuration of a wireless USB host in accordance with an exemplary embodiment of the present invention.

### DETAILED DESCRIPTION OF THE EXEMPLARY EMBODIMENTS

Advantages and features of the present invention, and ways to achieve them will be apparent from exemplary embodiments of the present invention described with reference to the accompanying drawings in the following. However, the scope of the present invention is not limited to such exemplary embodiments and the present invention may be realized in various forms. The exemplary embodiments disclosed in the specification are examples provided to assist those skilled in the art to completely understand the present invention. The present invention is defined only by the scope of the appended claims. Also, the same reference numerals are used to designate the same elements throughout the specification and drawings.

Hereinafter, exemplary embodiments of the present invention will be described in detail with reference to the accompanying drawings. It should be understood that combinations of each block and each operation of the accompanying block diagrams and flowcharts may be executed by means of computer program instructions. Since such computer program instructions may be loaded into a processor of a general-purpose computer, a special-purpose computer or other programmable data processing equipment, the instructions to be executed through the processor of the computer or other programmable data processing equipment creates means for executing the functions described in each block or each operation of the block diagrams or the flowcharts. Moreover, these computer program instructions may be stored in a computer or other programmable data processing equipment, or in computer-usable or computer-readable memory in order to realize such functions in a specific manner, so it is also possible to produce a system including instruction means for executing the functions described in each block or each operation of the block diagrams or the flowcharts. Furthermore, since the computer program instructions may be loaded into a computer or other programmable data processing equipment, it is also possible to provide stages for executing the functions described in each block or each operation of the block diagrams or the flowcharts by means of the instructions which operate the computer or other programmable data processing equipment by executing a series of operational stages in the computer or other programmable data processing equipment to generate a computer-executed process.

Also, each block or each operation may represent a part of a module, a segment or a code, including one or more executable instructions for executing a specific logical function or specific logical functions. In addition, it should be noted that the functions mentioned in the blocks or operations may occur out of order in several alternative exemplary embodiments. For example, two blocks or operations shown in succession may be executed substantially concurrently, or may be executed in reverse order according to corresponding functions.

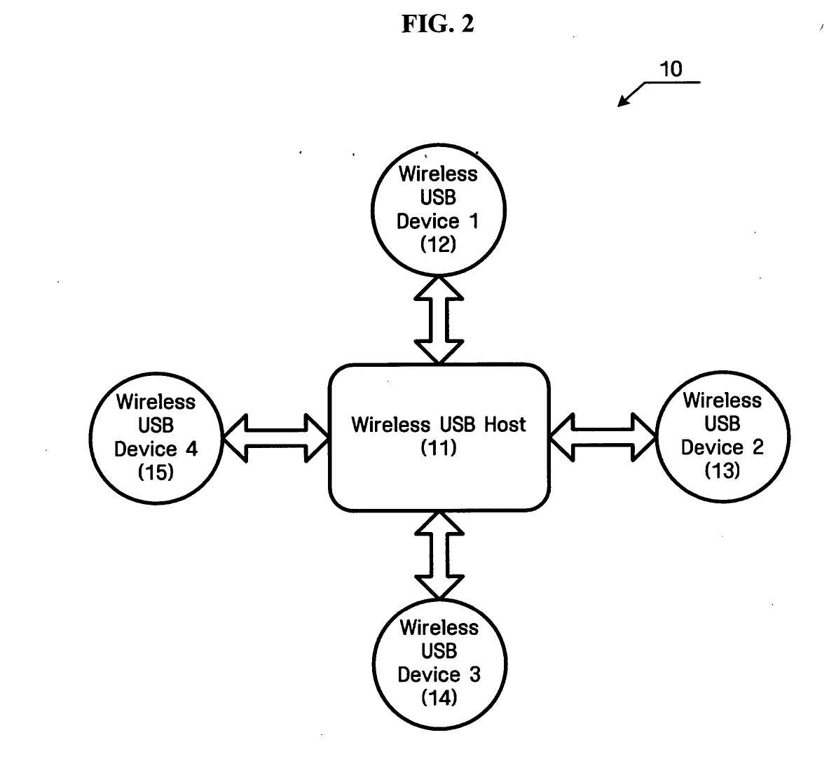

FIG. 2 illustrates an overall system architecture consisting of a wireless USB host and wireless USB devices.

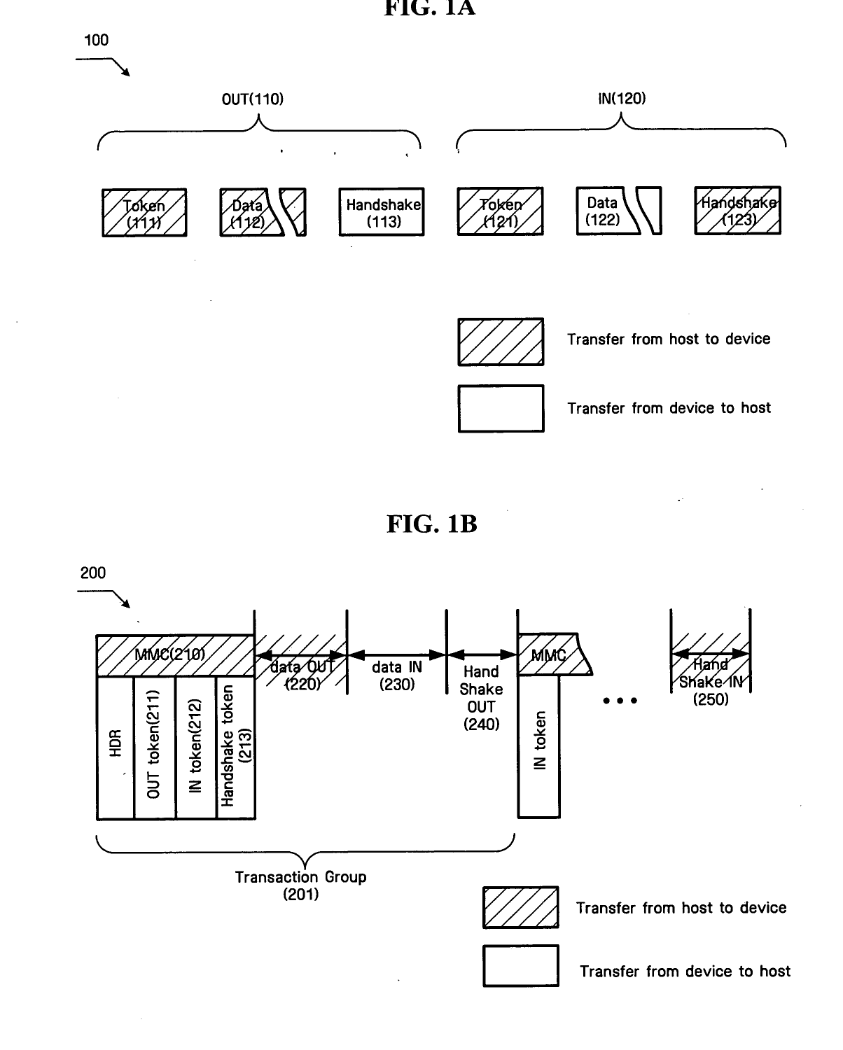

A wireless USB system 10 using a flow control method according to an exemplary embodiment of the present invention consists of one wireless USB host 11 and one or more wireless USB devices 12 to 15. As stated above in connection with FIG. 1, the host 11 generates and broadcasts an MMC packet including information on channel time slot allocation for devices desiring to communicate with the host as one IE. Each of the devices 12 to 15 receives and analyzes the MMC packet to check whether a buffer that stores data to be received from the host is ready, or data to be transferred to the host is prepared when a channel time is allocated thereto. In the case where there is no buffer or the data to be transferred to the host is not ready, the device transmits a negative acknowledgement (NAK) handshake informing the host of this status. At this time, the device inserts information on a time when the buffer or data will be prepared into a packet of the NAK handshake, thereby enabling the host to allocate channel time for the device having transmitted the NAK handshake at the corresponding time and giving the device a chance to participate in wireless USB communication.

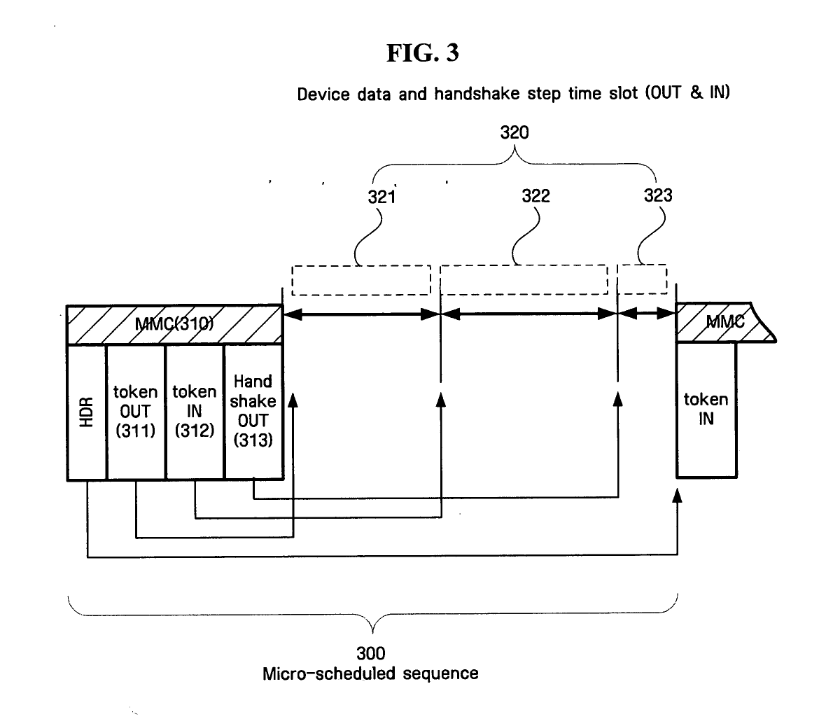

FIG. 3 illustrates a principle of an MMC for scheduling data communication between a wireless USB host and a wireless USB device.

A wireless USB micro-scheduled sequence 300 consists of one MMC 310 and subsequent channel times as will be described following the description of the MMC 310. The wireless USB uses the micro-scheduled sequence structure 300 for managing the wireless USB transaction protocol. The host uses the MMC 310 for maintaining and controlling a wireless USB channel. The MMC is a control packet defined by an application, and mostly consists of specific IEs. The MMC 310 shown in FIG. 3 includes channel time slot allocation information 311 for data OUT 321, channel time slot allocation information 312 for data IN 322, and channel time slot allocation information 313 for handshake OUT 323.

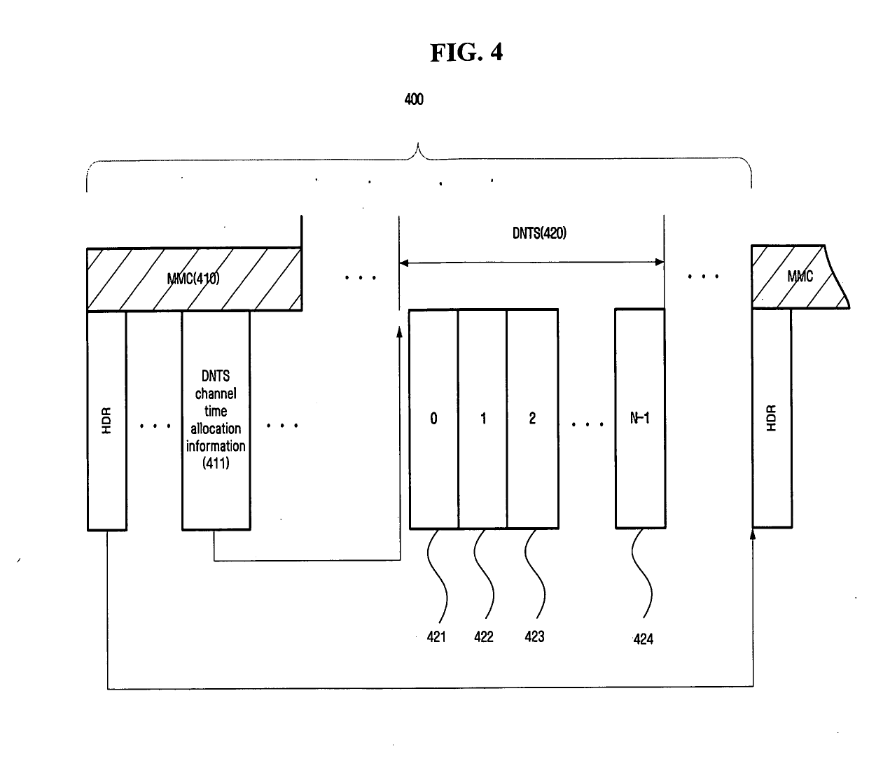

FIG. 4 illustrates a protocol according to which a wireless USB device transmits a Device Notification Time Slot (DNTS) message to a wireless USB host.

Flow control in conventional wireless USB communication is used for preventing a buffer underrun or buffer overrun state. For an IN transaction, if the device transmits an NAK handshake to the host in response to an IN token of the host, this means that data to be transferred to the host is not ready in the device. For an OUT transaction, if the device transmits an NAK handshake to the host in response to an OUT token of the host, this means that the device does not have sufficient buffer space for storing data received from the host. Afterwards, the host having received such flow control responses retries to communicate with the device by broadcasting an MMC including an IN or OUT token again.

At this time, if the buffer or data is ready in the device, the device can inform the host of the preparation of the buffer or data by transmitting a notification called “Device Endpoints Ready” to the host. Then, the host can allocate a channel time for the device having transmitted the notification. Such a notification is transmitted in a DNTS-slotted aloha scheme.

FIG. 4 shows a general model 440 for a DNTS configuration.

The host allocates the DNTS 420 in order to allow individual devices to transmit small and asynchronous notification messages to the host. The host includes DNTS channel time allocation information 411 in the MMC 410, thereby notifying the DNTS to the devices located in its coverage area. The DNTS is structuralized with message slots 421 to 424 of a logically uniform size. The DNTS channel time allocation information 411 includes the number of the message slots 421 to 424 of the DNTS.

USB 2.0 has flow control mounted to an upper layer protocol. For a wired USB protocol, once a device transmits a flow control response (NAK), a host must poll for a status change. A USB host controller frequently polls for changes in data stream readiness. Such “busy-wait” polling is a very expensive scheme in view of occupying an available bandwidth in a wireless environment. Therefore, a wireless USB utilizes a scheme in which a smaller bandwidth is consumed for restarting a data stream after a flow control event. It is assumed that initial statuses of all endpoints managing data transfer are in a “ready” status even after any configuration event.

A device can respond to any token request by a flow control response. An IN endpoint will return an NAK handshake packet in place of a data packet during a protocol time slot. An OUT endpoint always returns a handshake packet during a protocol time slot in a data operation in order to acknowledge a received data packet. An OUT handshake packet, one of major fields, has a handshake code field representing the kind of a handshake, and an acknowledgement (ACK) field. The kinds of an endpoint response are shown below in Table 1.

TABLE 1
Device Response Descriptions

| Host | Device response | Description |
|---|---|---|
| IN | DATA (X) | If transfer is not last one, host |
| | | progresses transfer status and |
| | | starts another transaction at |
| | | proper time. |
| IN | bmStatus.Handshake | Flow control response |
| | Code = NAK | |
| OUT DATA (X) | bmStatus.Handshake | Data may be further |
| | Code = ACK | transferred. |
| | bvAckCode ≠ 0 | |
| OUT DATA (X) | bmStatus.Handshake | Flow control response. |
| | Code = ACK | Device has accepted all data |
| | bvAckCode = 0 | transferred during time slot in |
| | | data operation, but there is no |
| | | more space. |
| OUT DATA (X) | bmStatus.Handshake | Flow control response. |
| | Code = NAK | Device has not accepted any |
| | | data transferred during data |
| | | operation. |

If a general host receives a flow control response from an endpoint, it removes an endpoint data stream from an active list of currently serviced endpoints. If an endpoint of a device is ready for restarting a data stream (this means that the endpoint has data or a storage space of a maximum packet size), the device transmits a message, which informs a host that the endpoints is ready, to the host, and the host restarts a transaction traffic to this endpoint in the next scheduled service period.

However, when such a conventional flow control method is used, the device can inform the host that the device is ready for data transfer or data reception only in a DNTS period. Since the DNTS period is a channel time arbitrarily allocated by the host, the DNTS period may not be allocated to the device and thus the device may not transmit a notification to the host although it is ready for data transfer or data reception. Also, a notification transmission scheme is a slotted aloha scheme, so it may take a long time for the device to transmit a notification when the device loses in competition with other devices.

In a flow control method according to an exemplary embodiment of the present invention, a device inserts information on a time when data to be transferred from the device will be prepared or storage space will be prepared into a flow control response, that is, a handshake packet. This enables a host to generate an MMC, on which the information is reflected, when the host next schedules data transfer.

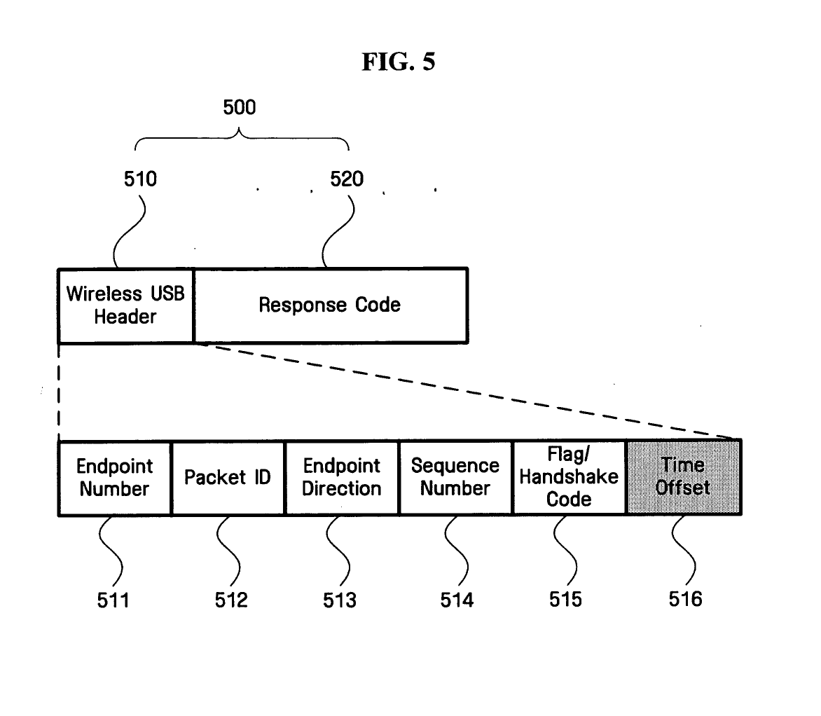

FIG. 5 illustrates a format of a response packet 500 which a device transmits to a host in response to an MMC packet for the sake of flow control in accordance with an exemplary embodiment of the present invention. Hereinafter, a description will be given focusing on an NAK handshake packet of wireless USB 1.0 as one example of the response packet. FIG. 5 show that information on a time when data to be transferred from the device will be prepared or information on a time when a storage space is prepared is inserted into a header portion of the handshake packet of the wireless USB 1.0. Here, the information on an estimated time may be, for example, a time offset value corresponding to a time interval from the current time to the estimate time. The handshake packet of the wireless USB 1.0 largely consists of two portions, that is, a header and a body having an ACK code value. The response packet 500 according to this exemplary embodiment also basically follows a format of the handshake packet of the wireless USB 1.0. Thus, the response packet 500 according to this exemplary embodiment consists of a wireless USB header 510 and a body 520.

The wireless USB header 510 can be divided into an endpoint number 511, a packet ID 512, an endpoint direction 513, a sequence number 514, a flag/handshake code 515 and a time offset 516. The endpoint number field 511 has a device endpoint number for identifying data transfer, and the packet ID field 512 has a value representing the kind of a packet. The packet ID (PID) field 512 may have the values shown below in Table 2.

TABLE 2
PID Details

| PID type | PID name | Value | Description |
|---|---|---|---|
| Data | DATA | 000 B | Data packet |
| | IDATA | 001 B | Isochronous data packet |
| Handshake | HNDSHK | 100 B | Handshake packet transmitted by |
| | | | device |
| Notification | DN | 101 B | Device notification |
| Reserved | | 010 B-011 B | Reserved value for future use |
| | | 110 B-111 B | |

Thus, the response packet according to this exemplary embodiment has a packet ID of “HNDSHK”.

The endpoint direction field 513 has a value representing an endpoint direction, i.e., a data transfer direction according to values of the PID field 512. This value signifies “OUT” if it is “0”, and signifies “IN” if it is “1”.

The sequence number field 514 has a data burst sequence number when the PID field 512 represents a DATA packet or an IDATA packet. In all cases except this case, the sequence number field 512 is set to “0”. The response packet according to this exemplary embodiment sets this field to “0”.

The flag/handshake field 515 is set as a status flag related to a data stream if the PID field 512 has a value of “DATA” or “IDATA”, and has a value of status information returned to the host if the PID filed 512 has a value of “HNDSHK”. This field has a value corresponding to “ACK” when the endpoint observes data or a confirmation command without errors, has a value corresponding to “NAK” when the endpoint is not ready for data transfer or data reception, and has a value of “STALL” when the endpoint is halted or a control transfer request is not supported. Thus, the handshake packet has the value corresponding to “NAK”.

The wireless USB 1.0 has a header of variable length in order to describe a configuration of isochronous data in the last portion of the header. The response packet shown in FIG. 5 diverts this header portion of variable length to a portion for including a time offset value. That is, the device inserts the time offset value into a portion 516 corresponding to the isochronous header of the wireless USB 1.0 and transmits the inserted time offset value to the host.

The body portion 520 has an acknowledgement code, and carries information on a result of the last data burst to the host when the handshake packet is an acknowledgement of a data burst in a data operation.

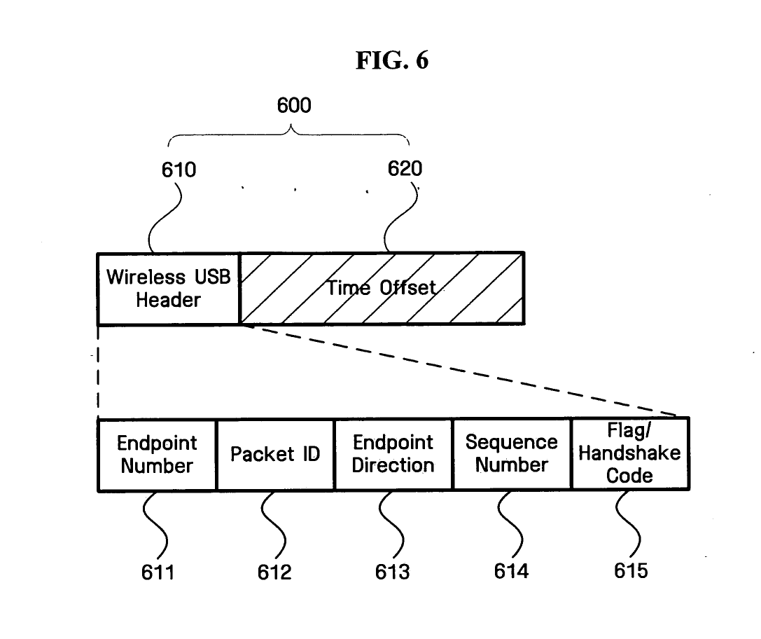

FIG. 6 illustrates a format of a handshake packet which a wireless USB device transmits to a wireless USB host for flow control in accordance with another exemplary embodiment of the present invention.

Whereas the above-mentioned exemplary embodiment of FIG. 5 includes information on a time when data to be transferred from a device will be prepared or information on a time when a storage space for storing data transferred from a host will be prepared, in the header portion 510 of the NACK handshake packet, FIG. 6 shows a packet format in which the time information is not included in a header portion, but is included in a body portion. That is, FIG. 6 shows a packet format in which a body portion 620 has a time offset value representing the information on a time when data to be transferred from a device will be prepared or the information on a time when a storage space will be prepared.

A format of a header portion 610 of the response packet shown in FIG. 6 is similar to that of the header portion of the response packet shown in FIG. 5. The header portion 610 includes an endpoint number 611, a packet ID 612, an endpoint direction 613, a sequence number 614 and a flag/handshake code 615. A description thereof will be omitted for avoiding repetition. The body portion 620 originally includes an ACK code value. However, in a flow control method according to this exemplary embodiment, the body portion 620 includes information on an estimated time when data to be transferred from a device will be prepared or information on an estimated time when a storage space will be prepared, for example, a time offset value from the current time to the estimated time when the response packet is an NAK handshake packet.

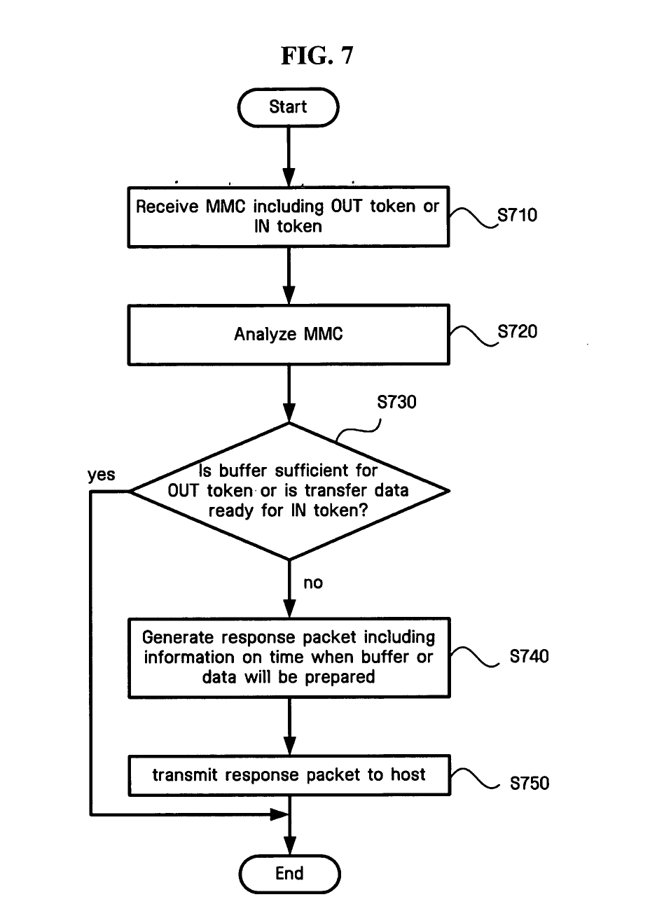

FIG. 7 is a flowchart illustrating operation procedures of a wireless USB device in accordance with an exemplary embodiment of the present invention.

The device according to this exemplary embodiment receives an MMC packet including an OUT token or IN token for scheduling data transfer between a host and the device (S710). The device analyzes the received MMC packet (S720) and, if there is an OUT token for the device itself, checks whether a buffer for storing data to be transferred from the host is prepared (S730). If the buffer of the device is insufficient (“No” in S730), the device estimates a time when a sufficient buffer for storing data to be transferred from the host will be prepared, and inserts a time offset time from the current time to the estimated time into a header portion 516 or a body portion 620 of an NAK handshake packet to generate a response packet (S740). The device transmits the generated response packet to the host to thereby inform the host of the time when the buffer will be prepared S750.

In addition, the device analyzes the received MMC packet (S720) and, if there is an OUT token for the device itself, checks whether data to be transferred to the host is prepared (S730). If the data to be transferred to the host is not prepared (“No” in S730), the device estimates a time when the data will be prepared next, and inserts a time offset time from the current time to the estimated time into the header portion 516 or the body portion 620 of the NAK handshake packet to generate a response packet (S740). The device transmits the generated response packet to the host to thereby inform the host of the time when the data to be transferred to the host will be prepared (S750).

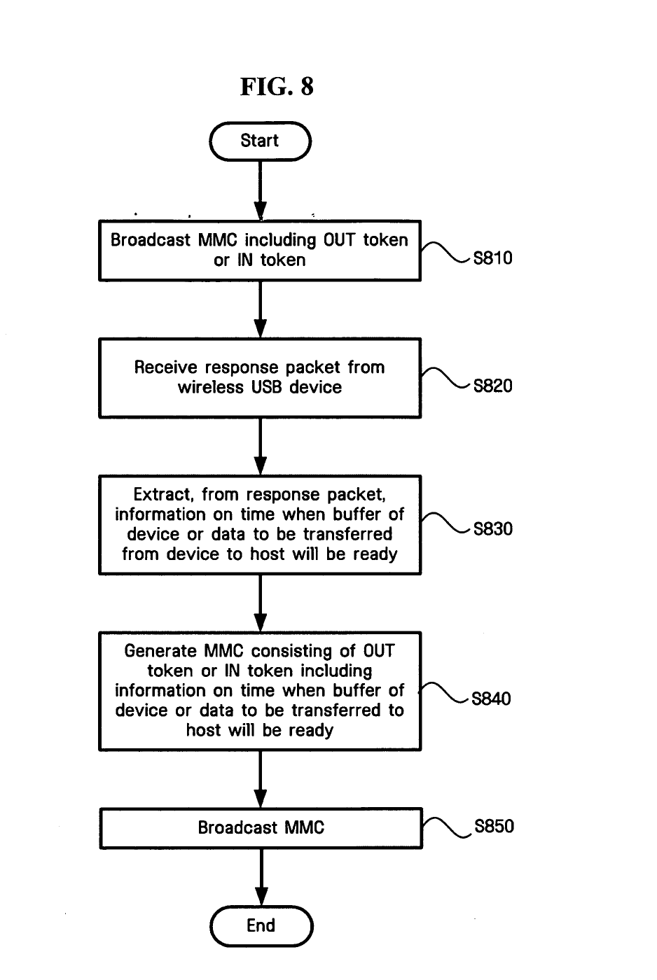

FIG. 8 is a flowchart illustrating operation procedures of a wireless USB host in accordance with an exemplary embodiment of the present invention.

The host according to this exemplary embodiment generates and broadcasts an MMC packet including an OUT or IN token in order to schedule communication with one or more wireless USB devices (S810). If the host receives an NAK handshake packet from the wireless USB device (S820), it analyzes the NAK handshake packet and extracts a time offset value inserted into the NAK handshake packet by the device (S830). In a case of an NAK handshake packet for the OUT token, this time offset value is information on a time when a buffer of the device will be prepared, that is, a time from the current time to an estimated time when a buffer of the device for storing data to be transferred from the host to the device will be prepared. Also, in a case of an NAK handshake packet for the IN token, this time offset value is information on a time when data to be transferred from the device to the host will be prepared, that is, a time from the current time to an estimated time when data to be transferred to the host. Based on the time offset value extracted from the NAK handshake packet, the host determines a channel time to be allocated to the corresponding device, and generates an MMC packet consisting of OUT and IN tokens including channel allocation information and information on a data transfer direction of the device (S840). The host broadcasts the generated MMC packet to all the devices (S850).

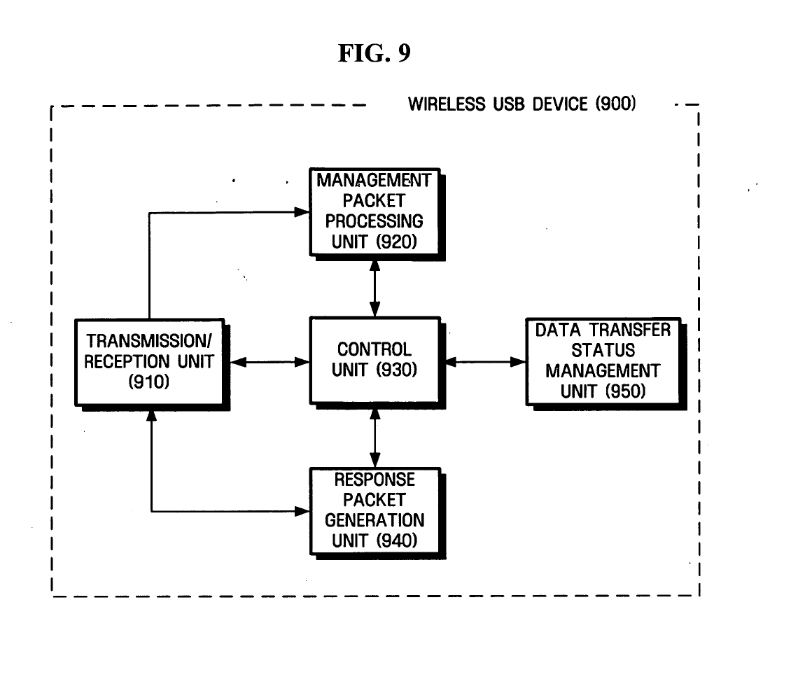

FIG. 9 is a block diagram illustrating a configuration of a wireless USB device in accordance with an exemplary embodiment of the present invention.

The wireless USB device 900 according to this exemplary embodiment may include a transmission/reception unit 910, a management packet processing unit 920, a control unit 930, a response packet generation unit 940 and a data transfer status management unit 950.

The transmission/reception unit 910 receives a data packet or an MMC packet transmitted from a host, and transmits a data packet or a response packet of the device to the host. The management packet processing unit 920 analyzes the MMC packet received by the transmission/reception unit 910, and extracts information on a data transfer direction and channel time information, which is necessary for the device to perform corresponding transfer, from an OUT or IN token for the device within the MMC packet.

The control unit 930 receives data transfer status information of a corresponding endpoint of the device from the data transfer status management unit 950, and decides if data transfer is possible, based on the channel time information and the necessary data transfer direction extracted by the management packet processing unit 920. That is, when the OUT token for the device is received, the control unit 930 decides if a buffer for storing data transmitted from the host will be prepared in an allocated channel time slot. Also, when the IN token for the device is received, the control unit 930 decides if data to be transferred to the host will be prepared in an allocated channel time slot. If the buffer or data is not prepared, the control unit 930 estimates a time when the buffer or data will be prepared next, and transmits information on the estimated time to the response packet generation unit 940.

If the buffer or the data to be transferred is not prepared in the corresponding channel time with respect to the received OUT or IN token, the response packet generation unit 940 generates a response packet, for example, an NAK handshake packet, based on the estimated time when the buffer or data will be prepared, which is transmitted from the control unit 930. The information on the estimated time is inserted into the NAK handshake packet at a position as described in FIGS. 5 and 6.

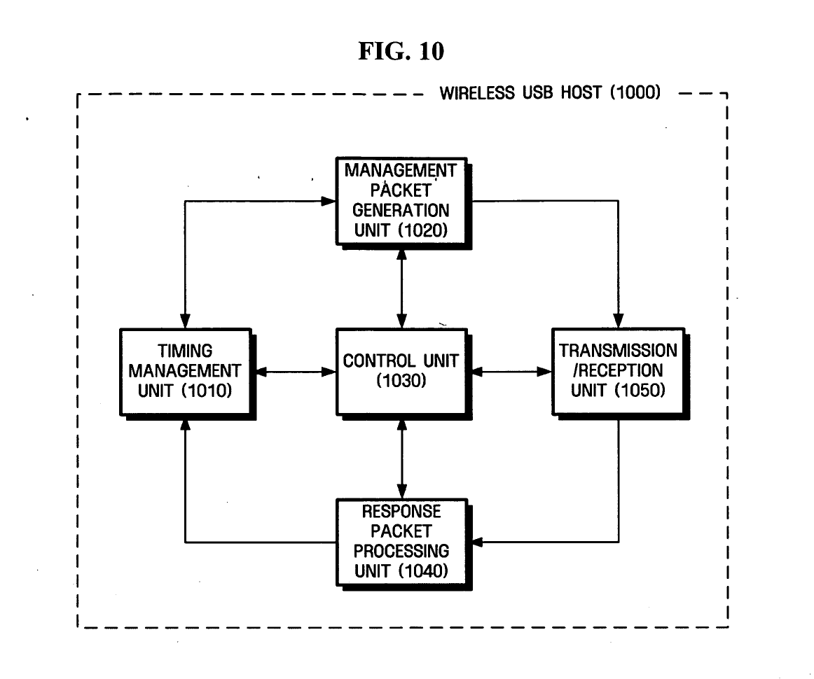

FIG. 10 is a block diagram illustrating a configuration of a wireless USB host in accordance with an exemplary embodiment of the present invention.

The wireless USB host 1000 according to this exemplary embodiment may include a timing management unit 1010, a management packet generation unit 1020, a control unit 1030, a response packet processing unit 1040 and a transmission/reception unit 1050.

The timing management unit 1010 manages timing for allocating a channel time to each device by a host performing data transfer to or data reception from a plurality of devices in a TDMA scheme. The management packet generation unit 1020 generates an MMC packet consisting of an OUT or IN token including channel allocation information for data transfer to or data reception from the one or more devices. The transmission/reception unit 1050 broadcasts the generated MMC packet to the devices and receives data packets or response packets from the devices.

The response packet processing unit 1040 analyzes the response packet received by the transmission/reception unit 1050 and, if the response packet is an NAK handshake packet, extracts information on a time when a buffer or data will be prepared, from a header portion 516 or a body portion 620 of the NAK handshake packet to deliver the information to the timing management unit 1010 or the control unit 1030. When the timing management unit 1010 receives the information on a time when the buffer or data of the device will be prepared, it manages a channel time for the device having transmitted the NAK handshake packet according to the received information, and allocates channel times for devices and delivers channel time allocation information to the management packet generation unit 1020. The management packet generation unit 1020 generates a new MMC packet according to the delivered channel time allocation information. The control unit 1030 controls operations of the timing management unit 1010, the management packet generation unit 1020, the transmission/reception unit 1050 and the response packet processing unit 1040.

In the above description, the respective components in FIGS. 9 and 10 may signify software or hardware such as a Field-Programmable Gate Array (FPGA) or an Application-Specific Integrated Circuit (ASIC). Functions provided in the components may be realized by more subdivided components or a plurality of components may jointly execute a specific function. Also, the components may be realized such that they cause one or more computers within the system to be executed.

Although exemplary embodiments of the present invention have been described for illustrative purposes, those skilled in the art will appreciate that various modifications, additions and substitutions are possible, without departing from the essential features and the scope and spirit of the invention as disclosed in the accompanying claims. Therefore, it should be appreciated that the exemplary embodiments described above are not limitative, but only illustrative.

What is claimed is:

1. A flow control method in wireless Universal Serial Bus (USB) communication, the method comprising:
receiving a wireless USB communication management packet comprising channel time allocation information and information on a data transfer direction for at least one wireless USB device that can communicate with a wireless USB host;
analyzing the wireless USB communication management packet;
if the wireless USB device does not have a sufficient storage space for storing data received from the wireless USB host or if data to be transferred to the wireless USB host is not prepared, generating, in response to the wireless USB communication management packet, a response packet comprising information on a time when the storage space or the data to be transferred to the wireless USB host will be ready; and
transmitting the response packet to the wireless USB host.

2. The method of claim 1, wherein the information on the time when the storage space or the data to be transferred to the wireless USB host will be ready is a time interval from a current time to an estimated time when the storage space or the data to be transferred to the wireless USB host will be ready.

3. The method of claim 1, wherein the response packet comprises a header portion comprising the information on the time when the storage space or the data to be transferred to the wireless USB host will be ready, and a body portion comprising information on a result of a data transfer.

4. The method of claim 3, wherein the header portion further comprises a number identifying a specific data transfer of the wireless USB device, a packet identifier representing a type of a packet, information on a data transfer direction, and a code representing that the response packet is in response to the wireless USB communication management packet.

5. The method of claim 1, wherein the response packet comprises a header portion and a body portion comprising the information on the time when the storage space or the data to be transferred to the wireless USB host will be ready.

6. The method of claim 5, wherein the header portion comprises a number identifying a specific data transfer of the wireless USB device, a packet identifier representing a type of a packet, information on a data transfer direction, and a code representing that the response packet is in response to the wireless USB communication management packet.

7. The method of claim 1, wherein the response packet is a negative acknowledgement handshake packet informing the wireless USB host that the storage space or the data to be transferred to the wireless USB host is not ready.

8. A flow control method in wireless Universal Serial Bus (USB) communication, the method comprising:
broadcasting a first wireless USB communication management packet comprising channel time allocation information and information on a data transfer direction for at least one wireless USB device that can communicate with a wireless USB host;
receiving a response packet, which comprises information on a time when a storage space for storing data transferred from the wireless USB host to the wireless USB device will be ready or information on a time when data to be transferred from the wireless USB device to the wireless USB host will be ready, from the wireless USB device;
extracting the information on the time when the storage space will be ready or the information on a time when the data to be transferred to the wireless USB host will be ready, from the response packet;
generating a second wireless USB communication management packet comprising channel time allocation information for the wireless USB device, which has transmitted the response packet, according to the extracted information; and
broadcasting the second wireless USB communication management packet.

9. The method of claim 8, wherein the information on the time when the storage space or the data to be transferred to the wireless USB host will be ready is a time interval from the current time to an estimated time when the storage space or the data to be transferred to the wireless USB host will be ready.

10. The method of claim 8, wherein the response packet comprises a header portion comprising the information on the time when the storage space or the data to be transferred to the wireless USB host will be ready, and a body portion comprising information on a result of a data transfer.

11. The method of claim 10, wherein the header portion further comprises a number identifying a specific data transfer of the wireless USB device, a packet identifier representing a type of a packet, information on a data transfer direction, and a code representing that the response packet is in response to the wireless USB communication management packet.

12. The method of claim 8, wherein the response packet comprises a header portion and a body portion comprising the information on the time when the storage space or the data to be transferred to the wireless USB host will be ready.

13. The method of claim 12, wherein the header portion comprises a number identifying a specific data transfer of the wireless USB device, a packet identifier representing a type of a packet, information on a data transfer direction, and a code representing that the response packet is in response to the wireless USB communication management packet.

14. The method of claim 8, wherein the response packet is a negative acknowledgement handshake packet informing the wireless USB host that the storage space or the data to be transferred to the wireless USB host is not ready.

15. A wireless (USB) device comprising:
a transmission and reception unit which receives a wireless USB communication management packet comprising channel time allocation information and information on a data transfer direction for at least one wireless USB device that can communicate with a wireless USB host;
a management packet processing unit which analyzes the wireless USB communication management packet;
a data transfer status management unit which determines whether there is a sufficient storage space for storing data transferred from the wireless USB host if the information on a data transfer direction represents data transfer from the wireless USB host to the wireless USB device, or whether data to be transferred to the wireless USB host is prepared if the information on a data transfer direction represents data transfer from the wireless USB device to the wireless USB host;
a control unit which estimates a time when the storage space or the data to be transferred to the wireless USB host will be ready if there is insufficient storage space for storing the data transferred from the wireless USB host or the data to be transferred to the wireless USB host is not ready; and
a response packet generation unit which generates, in response to the wireless USB communication management packet, a response packet comprising information on the estimated time.

16. The wireless USB device of claim 15, wherein the information on the estimated time is a time interval from the current time to an estimated time when the storage space or the data to be transferred to the wireless USB host will be ready.

17. The wireless USB device of claim 15, wherein the response packet comprises a header portion comprising the information on the time when the storage space or the data to be transferred to the wireless USB host will be ready, and a body portion comprising information on a result of a data transfer.

18. The wireless USB device of claim 17, wherein the header portion further comprises a number identifying a specific data transfer of the wireless USB device, a packet identifier representing a type of a packet, information on a data transfer direction, and a code representing that the response packet is in response to the wireless USB communication management packet.

19. The wireless USB device of claim 15, wherein the response packet comprises a header portion and a body portion comprising the information on the time when the storage space or the data to be transferred to the wireless USB host will be ready.

20. The wireless USB device of claim 19, wherein the header portion comprises a number identifying a specific data transfer of the wireless USB device, a packet identifier representing a type of a packet, information on a data transfer direction, and a code representing that the response packet is in response to the wireless USB communication management packet.

21. The wireless USB device of claim 15, wherein the response packet is a negative acknowledgement handshake packet informing the wireless USB host that the storage space or the data to be transferred to the wireless USB host is not ready.

22. A wireless Universal Serial Bus (USB) host comprising:
a transmission and reception unit which receives from the wireless USB device a response packet, which comprises information on a time when a storage space for storing data transferred from the wireless USB host to a wireless USB device will be ready or information on a time when data to be transferred from the wireless USB device to the wireless USB host will be ready;
a response packet processing unit which analyzes the response packet to extract the information on the time when the storage space will be prepared or the information the a time when the data will be ready;
a timing management unit which allocates a channel time for the wireless USB device having transferred the response packet while reflecting the extracted information to the allocation; and
a management packet generation unit which generates a wireless USB communication management packet comprising information on channel time allocation information and information on a data transfer direction for the wireless USB device.

23. The wireless USB host of claim 22, wherein the information on the time when the storage space or the data to be transferred to the wireless USB host will be prepared is a time interval from the current time to an estimated time when the storage space or the data to be transferred to the wireless USB host will be ready.

24. The wireless USB host of claim 22, wherein the response packet comprises a header portion comprising the information on the time when the storage space or the data to be transferred to the wireless USB host will be ready, and a body portion comprising information on a result of a data transfer.

25. The wireless USB host of claim 24, wherein the header portion further comprises a number identifying a specific data transfer of the wireless USB device, a packet identifier representing the type of a packet, information on a data transfer direction, and a code representing that the response packet is in response to the wireless USB communication management packet.

26. The wireless USB host of claim 22, wherein the response packet comprises a header portion and a body portion comprises the information on the time when the storage space or the data to be transferred to the wireless USB host will be ready.

27. The wireless USB host of claim 26, wherein the header portion comprises a number identifying a specific data transfer of the wireless USB device, a packet identifier representing a type of a packet, information on a data transfer direction, and a code representing that the response packet is in response to the wireless USB communication management packet.

28. The wireless USB host of claim 22, wherein the response packet is a negative acknowledgement handshake packet informing the wireless USB host that the storage space or the data to be transferred to the wireless USB host is not ready.

29. A recording medium recorded with a computer-readable program for executing a flow control method in wireless Universal Serial Bus (USB) communication, the method comprising:
receiving a wireless USB communication management packet comprising channel time allocation information and information on a data transfer direction for at least one wireless USB device that can communicate with a wireless USB host;
analyzing the wireless USB communication management packet;
if the wireless USB device does not have a sufficient storage space for storing data received from the wireless USB host or if data to be transferred to the wireless USB host is not prepared, generating, in response to the wireless USB communication management packet, a response packet comprising information on a time when the storage space or the data to be transferred to the wireless USB host will be ready; and
transmitting the response packet to the wireless USB host.

30. A recording medium recorded with a computer-readable program for executing a flow control method in wireless Universal Serial Bus (USB) communication, the method comprising:
broadcasting a first wireless USB communication management packet comprising channel time allocation information and information on a data transfer direction for at least one wireless USB device that can communicate with a wireless USB host;
receiving a response packet, which comprises information on a time when a storage space for storing data transferred from the wireless USB host to the wireless USB device will be ready or information on a time when data to be transferred from the wireless USB device to the wireless USB host will be ready, from the wireless USB device;
extracting the information on the time when the storage space will be ready or the information on a time when the data to be transferred to the wireless USB host will be ready, from the response packet;
generating a second wireless USB communication management packet comprising channel time allocation information for the wireless USB device, which has transmitted the response packet, according to the extracted information; and
broadcasting the second wireless USB communication management packet.
